(19) United States
(12) Patent Application Publication
(10) Pub. No.: US 2020/0045374 A1
(43) Pub. Date: Feb. 6, 2020

(54) ORGANIZING ALTERNATIVE CONTENT FOR PUBLICATION

(71) Applicant: PCCW VUCLIP (SINGAPORE) PTE. LTD., SINGAPORE (SG)

(72) Inventors: Rajan Annadurai, Palo Alto, CA (US); Marina Sidorko, San Jose, CA (US)

(21) Appl. No.: 16/051,412

(22) Filed: Jul. 31, 2018

(51) Int. Cl. H04N 21/472; G06F 17/30; G06F 3/01

(52) U.S. Cl. CPC H04N 21/472; G06F 3/017; G06F 17/3082; G06F 17/30867

(57) ABSTRACT

A unified content publishing system permits packaging and publishing of alternative content items to multiple sites in a single user interface. Multiple alternatives of a content item are grouped together. A user interface includes elements that divide the content item to enable the viewing user to select between the alternatives of the content item.

### TECHNICAL FIELD

Embodiments relate generally to electronic content publishing, and, more specifically, to techniques for organizing alternative content items using a centralized publication tool.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online content distributors publish a variety of media content items to consumers. Published content items may range from amateur, user-uploaded video clips to high-quality television shows and movies. A content distributor publishes a content item by making the content item available electronically to client computing devices through one or more access mechanisms known as channels or sites. Such sites may include different web sites, web applications, mobile or desktop applications, online streaming channels, and so forth. A site may be hosted by the content distributor itself, or by another entity, such as an Internet Service Provider or web portal. A site may freely publish a content item to all client devices, or impose various access restrictions on the content item, such as requiring that the client device present credentials associated with a valid subscription that permits access to the content item, or requiring that the client device be accessing the site through a certain provider or within a certain geographic area.

A content distributor may distribute media content items produced by other entities, referred to herein as content providers, as well as the distributor itself. A content distributor may publish content that the distributor has stored within its own system on behalf of the content provider. For instance, if the content item is a video, the content provider may send a video file to the content distributor, and the content distributor may store and optionally process the video file for various purposes. The content distributor may then publish the content item from this location through its own servers. Or, the content distributor may publish a content item by publishing a link through which a consumer retrieves the content item from a location at which the content item is hosted by the content provider or another suitable entity.

Generally, the publishing of the content item involves various steps such as sending electronic data in which the content item has been encoded to one or more client devices over a computer network, and/or sending one or more client devices a “link” that indicates a location from which such electronic data may be requested over a computer network. Moreover, publication may also require preliminary steps such as identifying where within the site a content item should be published and in what manner the publication should occur. For instance, a web site may include a number of different pages targeted to different audiences and purposes. Publication may require determining on which pages to publish the content item, as well as in which specific places and in which specific forms (e.g. links, menus, embedded videos, etc.) the content item should be published within the determined page(s).

A content distributor may publish content items utilizing a content publishing system. A content publishing system provides user interfaces by which site administrators may identify which content to publish, and the manner of publication. In some cases, multiple versions of a content item may exist, such as a special “director's cut” version, or a premium version which may require an additional subscription. However, existing systems publish these different versions as separate content items. This may lead to user confusion on the benefit of the premium version and results in less consumption of the alternate version.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an example screenshot of a user interface of traditional content publishing systems;

FIG. 1B is an example screenshot of a user interface of an example content publishing system;

FIG. 1C is an illustrative view of various aspects of an example system in which the techniques described herein may be practiced;

FIG. 2 is an illustrative view of various aspects of an example content publishing system;

FIG. 3 illustrates an example interaction diagram for presenting alternate versions of content items;

FIG. 4 illustrates an example flow for publishing alternate versions of content within a package;

FIGS. 5A-B illustrate an example user interface for selecting between alternate versions of content within a package; and

FIG. 6 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Content Items
2.2. Content Repository
2.3. Content Packages
2.4. Publication Sites
2.5. Subsites
2.6. Content Metadata Descriptors

3.0. Functional Overview

4.0. Example Interfaces

5.0. Implementation Mechanism—Hardware Overview

6.0. Extensions and Alternatives

### 1.0. General Overview

Approaches, techniques, and mechanisms are disclosed for a unified content publishing system through which alternate versions of a content may be packaged and published as a single content item, enabling users to interact between different versions of content within a single user interface. According to one embodiment, content items are grouped together using content groupings, which are also referred to as contexts. A single content grouping may be assigned for publication through multiple sites. The content grouping may furthermore be assigned template data and layout data for generating a content package comprising information about the content items in the content grouping. A content package may include links to content items, excerpts or previews of content items, or even the content items themselves. To simplify publication, the template data and layout data may be used to publish the content grouping across all sites to which the content grouping has been assigned. Content packages may be manipulated across multiple sites simply by editing the content grouping, the assigned template data, and/or the assigned layout data.

In an embodiment, some or all of the above assignment processes are facilitated by use of a construct referred to herein as a placeholder. A content administrator user may generate a placeholder and associate the placeholder with a context identifier as well as one or more sites. The placeholder carries with it some or all of the template data and layout data. In an embodiment, different types of placeholders have different template data and/or layout data, such that simply by creating a placeholder of a certain type and associating that placeholder with a context identifier, a content administrator user is assigning the template data and layout data associated with that type to the placeholder. For example, an episode may have multiple alternatives, or versions. A placeholder for the episode may have template data information that includes user interface elements that enable a viewing user of the episode content to interact with and choose between the different alternatives, or versions, of the content. A content publishing system may rely on placeholders before receiving content.

In an embodiment, publication sites are subdivided into subsites, corresponding to different publication attributes such as language profiles or themes. For example, with a given site, there may be separate subsites for each of a plurality of different languages. Content groupings may be assigned to distinct subsites rather than sites. In an embodiment, a placeholder may be assigned to a specific publication attribute, such as a specific language profile. The content grouping associated with the placeholder is thus automatically published to all subsite(s) having that specific language profile or other publication attribute on the sites that have been assigned to the placeholder.

In an embodiment, template data and/or layout data for a content grouping that has been associated with several sites or subsites may be overridden at the individual site or subsite level. For instance, a placeholder that has been assigned to all sites having a certain language profile may be associated with override data that changes the way a content package is generated for the placeholder on just a specific one of those sites.

A single user interface may be used to present two or more alternate versions of a content item. For example, a user may swipe left or right in a user interface element to access a preview of an alternate version of a content item, such as an episode of a television series. If there are more than two versions of a content item, a user may swipe multiple times left or right, as an example. Other directionalities may be used to divide the alternate versions of content within the user interface. In one embodiment, a divider may be animated within the user interface element to reveal a portion of a preview of each alternate version of content. Metadata descriptor tags may be retrieved and presented within the user interface element as an overlay over the respective version of content, such as “scary” and “super scary,” and/or “Premium,” over one or more alternate versions of the content item.

In other aspects, the invention encompasses computer apparatuses and computer-readable media configured to carry out the foregoing techniques.

### 2.0. Structural Overview

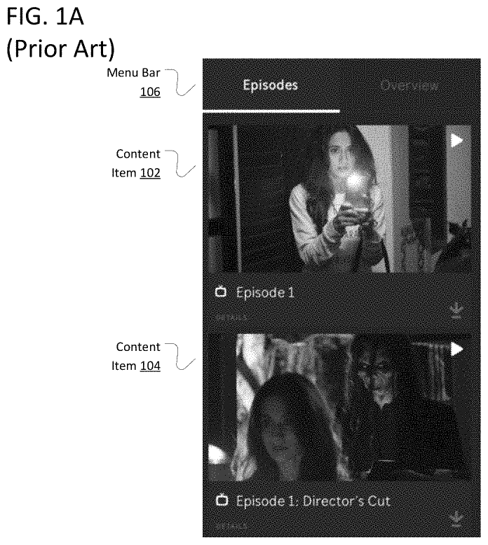

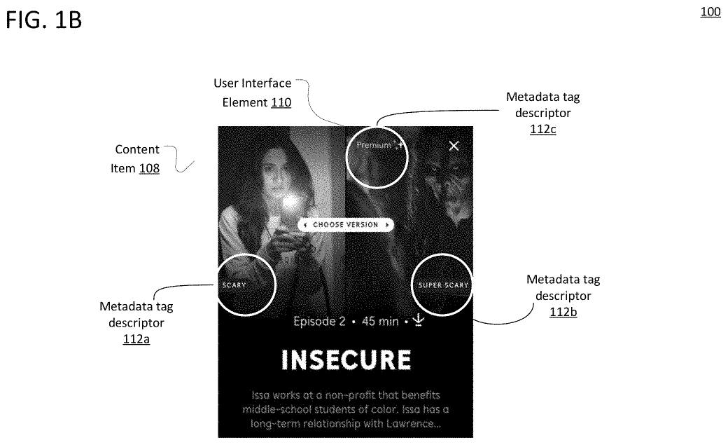

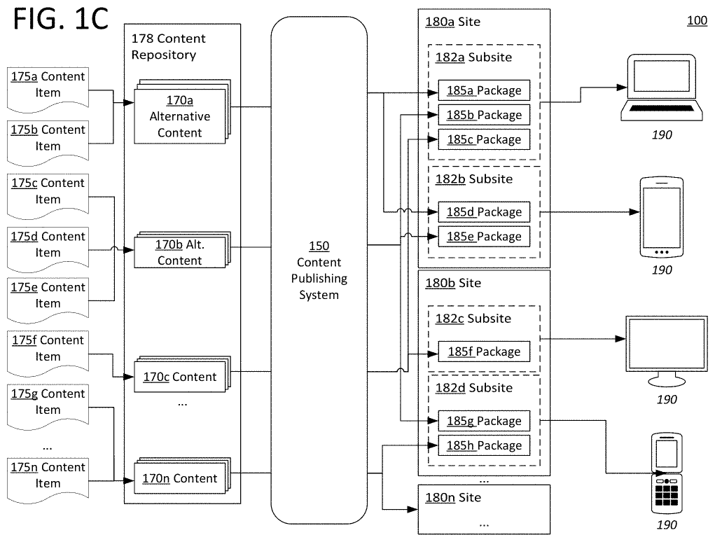

FIG. 1A is an example screenshot of a user interface of typical content publishing systems. As shown, a user interface of a system may include a content item 102 and a content item 104 presented as separate items under a menu bar interface 106. Here, content item 102 refers to “Episode 1” whereas content item 104 refers to “Episode 1: Director's Cut,” indicating through text to a user that content item 104 includes additional material. Upon selecting, or interacting with, content item 102 or content item 104, the associated content may be retrieved for viewing within the user interface. However, this prior art approach reveals the lack of technological sophistication in presenting the alternate versions of the same content. This prior art approach relies on the title of the content item to encourage or entice the user to select the “Director's Cut” version, which does not convey the type of content included in the content item 104, nor does it convey any special added value to the user (e.g., additional audio/video, alternate content/scenes, etc.) that may be included within the content item 104.

In contrast, FIG. 1B is an example screenshot of a user interface of an example content publishing system that graphically presents a user with more useful information about the choice of selecting between alternate versions of the content item. Here, content item 108 includes a user interface element 110 that divides the content item 108 into a left-side and right-side version of the content. In this example, the user interface element 110 includes a label “CHOOSE VERSION” with arrows pointing left and right within the label. The relative area of each thumbnail as shown in the user interface of content item 108 can be decided by a backend persona analysis engine in an embodiment. For example, the left-side thumbnail may occupy 45% of the entire content item 108 and the right-side thumbnail may occupy the remaining 55% of the content item 108. In other embodiments, any number of personal preference intelligence mechanisms may be used to determine the relative area of each thumbnail for a particular user. Metadata descriptor tags 112a, 112b, and 112c are also included as overlays on the content item 108 to describe qualitatively the alternate versions of the content included in the content item 108. Metadata descriptor tag 112a includes a label “SCARY” that may be retrieved from a data store within the system 100. Metadata descriptor tag 112b includes a label “SUPER SCARY” while metadata descriptor tag 112c includes a label “PREMIUM.” Returning to the example above, a personalized preference engine may determine that for a viewing user regarding “SCARY” versus “SUPER SCARY” is 30% vs. 70%. As a result, the thumbnail area as initially shown for that user may include 30% of the “SCARY” thumbnail and 70% of the “SUPER SCARY” thumbnail. This vastly improves the user experience by efficiently presenting content options to the user and thereby reduces the amount of time and processing power that it takes to store, organize, and display content options over the prior art approaches.

FIG. 1B and the other figures use like reference numerals to identify like elements. A letter after a reference numeral, such as “112a,” indicates that the text refers specifically to the element having that particular reference numeral. A reference numeral in the text without a following letter, such as “112,” refers to any or all of the elements in the figures bearing that reference numeral (e.g. “112” in the text refers to reference numerals “112a,” “112b,” and/or “112c” in the figures). Only three metadata descriptor tags 112 are shown in FIG. 1B in order to simplify and clarify the description.

FIG. 1C is an illustrative view of various aspects of an example system in which the techniques described herein may be practiced, according to an embodiment. System 100 comprises one or more computing devices. These one or more computing devices comprise any combination of hardware and software configured to implement the various logical components described herein, including components 150-190. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

### 2.1. Content Items

System 100 facilitates the publishing of content items 175 by a content distributor to client devices 190. Content items 175, collectively depicted as content items 175a-175n, are digital files or streams that encode distinct items of electronic media, such as digital movies, digital television shows, digital video clips, digital music, or any other suitable electronic media. Some or all of content items 175 may be stored in a repository (e.g., database, file system, etc.) of content controlled directly by the content distributor. Some or all of content items 175 may be stored in external systems. Such content items 175 may be, for example, files or streams that are retrievable via requests to web server(s), content provider server(s), or to other types of server(s) that access those external systems, using uniform resource locators (URLs) or other suitable identifiers.

### 2.2. Content Repository

In publishing content items 175, system 100 comprises a content repository 178 of contents 170a-170n (collectively contents 170) that include a mix of alternative (alt.) contents 170a and 170b as well as regular content 170c-170n that may not have alternate versions of the same content. As used herein, a content is a grouping of one or more content items packaged as a single content item, which may or may not have a predefined order. A content may be described by a data structure, or collection thereof, having a unique context identifier and containing references to one or more content items, which are said to be mapped to, be associated with, or belong to the content. For instance, content items 175a-175b are depicted, for illustrative purposes, as mapped to alternative content 170a, while content items 175c-e are depicted as mapped to alt. content 170b. Note that a single content item 175f may be mapped to a single content 170c.

Depending on an embodiment, there may or may not be any constraint upon the source of content items 175 in a given content 170. For example, in one embodiment, a content 170 may comprise content items 175 both from one or more external streaming sources and from the content distributor's content repository. In another embodiment, a given content 170 may only include content items 175 from a single source and/or a single content provider. In an embodiment, the content items 175 in a content 170 may change over time, in which case the content items 175 currently in a content 170 may be determined by accessing the content 170 by its unique identifier(s) within the content repository 178.

An alternative content 170 may be created for a variety of reasons. For instance, a content administrator user may create the alternative content 170 to associate a collection of alternate versions of a particular content item. Or, the content administrator user may create the alternative content 170 based on different versions of the content item that may occur based on a viewing user's input during playback of the content item. For example, if the viewing user selects a user interface element during a scene, such as a door highlighted, the result may be a link to an alternate ending based on the character opening the door. In another embodiment, a director's cut may be accessed based on the viewing user selecting a version of the content item and the viewing user having access rights to the content based on a paid subscription.

Data describing the available contents 170 may be stored in a suitable repository 178 of contents 170, such as a database or file system. Depending on the embodiment, the content repository 178 may or may not be part of the content publishing system 150. Moreover, in some embodiments, there may be multiple content repositories 178. For instance, the content distributor may publish content items 175 to multiple sites 180, some or all of which may be hosted by different entities (e.g., service providers, web portals, etc.). Some or all of the entities may have their own separate and distinct content repositories 178 to which the content distributor has access. Or, different content providers may have their own content repositories 178.

### 2.3. Content Packages

System 100 comprises a content publishing system 150 that is configured to, among other aspects, generate content packages 185 based on the contents 170. The content publishing system 150 is a combination of one or more computer devices collectively functioning as a server-based computer system to perform the publishing techniques described herein.

A content package 185 is a presentation of the content items 175 that are mapped to a content 170. A content package 185 is represented by display instructions in a suitable format, such as Hyper-text Markup Language (HTML) elements, XML elements, JavaScript code snippets, and/or other suitable data structures or code. The presentation embodied by the content package 185 may function as a content listing of some or all of the content items 175 to which a given client 190 has access, and may range from a simple listing of titles and accompanying links to more sophisticated displays such as a newsfeed-style collection of content excerpts, or an automatically scrolling banner in which each content item 175 is playable.

For example, a content package 185 may be a video element within a web page that automatically plays each content item 175 in a content 170 in succession, potentially in an order prescribed by the context 170. Or, a content package 185 may be a bulleted list of links to each content item 175. Or, a content package 185 may be a series of thumbnails for the content items 175 in a content 170, with or without accompanying metadata and links. Of course, content items 175 may be presented in a variety of ways, and the techniques described herein are not necessarily limited to any particular presentation techniques or formatting options within the content packages 185.

According to an embodiment, content packages 185 may conform to different specified types, such that one content package 185 of a certain type may have a same general appearance and arrangement as another content package 185 of the same type. For example, one type of content package 185 may be arranged for presentation as a banner within a web page or application, while another type may be arranged for presentation as a feature within the web page or application, while another type may be arranged for presentation within a category section or link section within the web page or application. To this end, the content publishing system 150 may map contents 170 to different templates.

A template comprises specific instructions for generating a specific type of content package 185 based on any given content 170. For example, a template may comprise non-variable elements and variable elements. A content package 185 may be generated by copying the template, leaving the non-variable elements unchanged, but replacing the variable elements with data indicated by the content 170. These non-variable elements are typically formatting elements, such as specific HTML tags or JavaScript presentation instructions, while the variable elements are typically metadata for the content 170 or content items 175, such as titles, genres, descriptions, URLs, and so forth. There are a number of templating mechanisms that provide similar results, and the described techniques are not limited to any specific type of templating mechanism. Note that any number of content packages 185 may be generated for a single content 170, and these content packages 185 may or may not be associated with the same template, and thus may or may not have similar appearances.

### 2.4. Publication Sites

The content publishing system 150 is further configured to publish the content packages 185 to a plurality of sites 180a-180n, collectively sites 180. A site 180 may be for example, one or more web sites, web portals, applications, or other electronic publication mechanisms. A site 180 is more generally an electronic publishing interface provided by one or more server computing devices, such as web servers or application servers, by which client computing devices 190 may request and receive information over one or more networks, such as the Internet. Client computing devices 190 may be, for example, desktop computers, laptop computers, tablet devices, smartphones or other mobile devices, set top devices, gaming consoles, and so forth, which execute web browsers and/or other applications to request information from sites 180 and display that information locally on monitors or other output devices.

Sites 180 may be hosted by any number of server systems operated by any number of entities. For example, in one embodiment, each site 180 is hosted by a same server system, but is separately addressable, such that the server system may determine from which site 180 a client 190 is requesting information based upon identifying information in the request (e.g. the domain name to which a request is directed, information in the URL path being requested, query string information, etc.). In another embodiment, at least some of the sites 180 may be hosted by different server systems. For example, the content distributor may operate multiple server systems on behalf of different entities, and each server system may host one or more sites 180. Or, the content distributor's system may publish content packages to sites 180 that are operated by different entities.

Sites 180 may communicate information in the form of, for example, web pages, JSON data structures, XML data structures, API responses, and so forth. The information typically includes presentation instructions, such as HTML, JavaScript, and/or other suitable instructions, that indicate how the information is to be arranged and displayed as a presentation at a client 190. The presentation instructions may include instructions to request and play content items 175 directly within sections of the presentations (e.g., sections corresponding to the content packages 185 that contain the various content items 175, etc.), and/or the presentation instructions may instruct the client device 190 to display links or other interface controls that, when selected by user input, cause the client device 190 to separately request and play the content items 175 outside of the presentation.

Client devices 190 may or may not access content items 175 through sites 180 directly. For example, the content distributor's system may include a separate server for sending or streaming certain video content, and the presentation instructions may direct clients 190 to request content items 175 from this separate server rather than from sites 180. As another example, if a content item 175 is hosted by an external source, the presentation instructions may instruct a client device 190 to stream the content item 175 from the external source rather than a site 180.

Content publishing system 150 may be configured to publish content packages 185 to sites 180 using any of a variety of techniques, depending on the embodiment. For instance, if a site 180 comprises a plurality of web pages stored as static, flat files, content publishing system 150 may publish a content package 185 by inserting the content package 185 within a corresponding web page file and saving the updated file. If the site 180 is hosted externally, the content publishing system 150 may instead publish the content package by sending the content package 185 along with appropriate insertion instructions to the web server at which the site 180 is hosted, and the web server may then perform the necessary insertion steps. The content package 185 may be periodically updated (e.g. to reflect changes to the appropriate content 170), and republished within the appropriate web page using the same technique.

As another example, if the site 180 comprises web pages that are generated dynamically, content publishing system 150 may initiate publication of a content package 185 by updating configuration data, database entries, or other suitable data in such a manner so as to ensure that an appropriate dynamically generated web page will include the content package 185 when generated. Similarly, if the site 180 is an application configured to present information provided by an application server, content publishing system 150 may initiate publication of a content package 185 by updating configuration data, database entries, or other suitable data in such a manner so as to ensure that the application server's responses include information for the content package 185.

In embodiments where a content package 185 is embedded within a dynamically generated web page or other presentation, the content publishing system 150 may or may not generate the content package 185 dynamically, based on the appropriate content 170. For instance, a web server or application server responsible for generating a web page or other presentation in which the content package 185 is to be published may send a request to the content publishing system 150 to return the content package 185 each time the web page or presentation is requested by a client 190. In some embodiments, however, the content package 185 may be generated periodically by the content publishing system 150 and cached (either by the content publishing system 150 or the web/application server), so as to reduce processing requirements.

In an embodiment, the content publishing system 150 includes the web server or application server system that hosts a site 180. Hence, steps for generating a content package 185 may be integrated directly into the steps for generating a web page or other presentation of information for the site 180.

### 2.5. Subsites

According to an embodiment, each site 180 may comprise one or more subsites 182. Each subsite 182 presents a different view of content items 175 available through the corresponding site 180, filtered and/or arranged differently for different purposes. A site 180 may have different subsites 182 for different languages or regions. For instance, a site 180 may comprise an English language subsite 182a, a Chinese language subsite 182b, and an Indonesian language subsite 182c. A site 180 might also have different subsites 182 for different events, themes, interest groups, demographic groups, and so forth. For instance, a site 180 may comprise a Bollywood-themed subsite 182a, a Christmas themed subsite 182b, and a Teen-themed subsite 182c. Different subsites 182 may also exist for different subscription levels, or any combination of the foregoing. More generally, different subsites 182 may exist for each of a plurality of different publication attributes, or combination thereof, including language profiles, themes, events, and so forth.

In an embodiment, each subsite 182 is a separately addressable web page or section within a web site, or a separately navigable tab or screen within an application. In this aspect, a subsite 182 may be considered a different channel of content on the site 180. In an embodiment, upon accessing a site 180, a visitor to the site is automatically presented with content from a designated subsite 182 that is associated with the visiting client device 190. The subsite 182 to associate with the visiting client device 190 may be determined based on any of a variety of factors, such as user credentials presented by the client device 190, demographic or language preferences associated with the device 190 or the user credentials, a subscription level associated with the device 190 or the user credentials, a geographic region associated with the device 190 or the user credentials, the current date and time, and so forth. However, depending on the embodiment, a visitor may still be able to access content from other subsites 182 using various navigation menus and/or by browsing to the address of another subsite 182 directly.

### 2.6. Content Metadata Descriptors

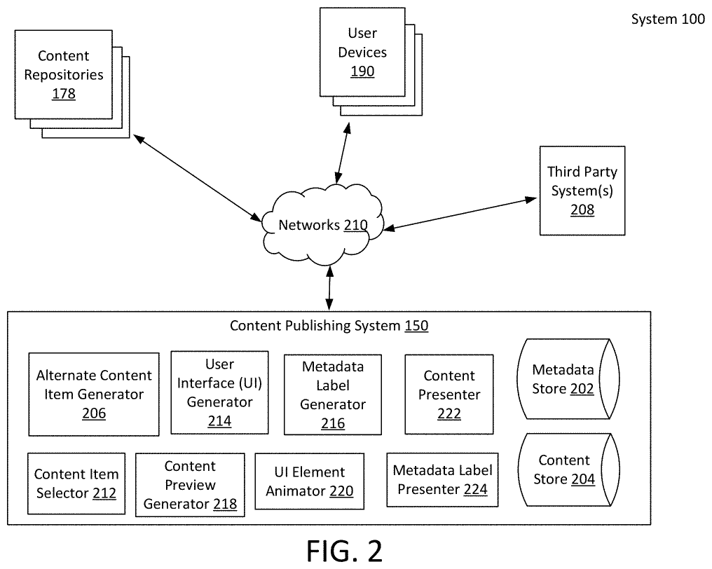

FIG. 2 is an illustrative view of various aspects of an example content publishing system 100, according to an embodiment. System 100 comprises one or more computing devices. These one or more computing devices comprise any combination of hardware and software configured to implement the various logical components described herein, including components 202-224. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

System 100 includes an example of content publishing system 150 as illustrated in FIG. 1C. Other content publishing systems 150 may have fewer or additional elements in varying arrangements.

Content publishing system 150 may be utilized in conjunction with an alternate content item generator 206, configured to generate and/or edit data describing alternative contents 170. According to an embodiment, an alternative content 170 may be created in the course of human interaction with a context editing interface, or “tool,” provided by the alternate content item generator 206. A human operator may access a user interface (e.g., a web-based interface, a graphical user interface provided by a software application, etc.) in which the human operator may request to create a new alternate content 170, or to access a named alternate content 170 that was previously created and stored in a content repository 178. The human operator may assign or edit various characteristics of the content 170 such as a name, unique identifier(s), descriptions, attributes, or other metadata. The human operator may specify content items 175 to add and/or remove from the content 170 by specifying an external URL, internal identifier, or any other suitable reference for the content item 175. Of course, a variety of other types of interfaces are possible. For instance, an interface control may be provided in connection with a web page or web browser, by which a user may indicate that a video that the user is currently watching should be added to either a previously selected default content 170, or to a content 170 that the user then selects from a pull-down menu or other interface. Thus, content repository 178 may include, as part of the data structure, a content flag that organizes the multiple alternative content items 170 as a grouping to be associated with the respective content item 175. These multiple alternatives may then be graphically displayed by the content publishing system 150 in a single content item 175. In other embodiments, the content repository 178 is automatically set up to include one or more content flags that organizes the multiple alternative content items 170 as a grouping to be associated with the respective content item 175. In this way, the system is instructed to display a two, three, four, or however many number of panels for the main and alternate content files for a specific content title. Similarly, various contexts that the user is in (e.g., Chinese language, sci-fi movies, or a specific movie title) may be stored in the content repository 178 as information associated with the respective content item 175, according to an embodiment.

A content item 175 includes a data structure that informs the content publishing system 150 that multiple content is available for display within the content item 175. A placeholder may be used by the content publishing system 150 that provides a template of what may be graphically presented. The placeholder may then rely on a content flag associated with the content item 175 that indicates that multiple versions, or alternate content 170 is available. The placeholder may dynamically retrieve template and layout data that instructs the content publishing system 150 on how to graphically present the multiple versions of the content item 175. For example, a content item 175 with 4 different versions may have a content flag associated with the content item 175 that indicates that template and layout data for 4 pieces of alternative content 170 is needed.

Alternate content item generator 206 may also or instead add content items 175 to an alternative content 170 programmatically. For example, a content administrator user may specify that content items 175 having a particular parameter, such as a content flag, be mapped to particular alternative content 170. In this way, alternate versions of a content items may be mapped to an alternative content 170 in an automatic manner.

FIG. 2 illustrates a high-level block diagram, including an example content publishing system 150, according to an embodiment. A content publishing system 150 may include an alternate content item generator 206, a user interface (UI) generator 214, a metadata label generator 216, a content presenter 222, a metadata store 202, a content item selector 212, a content preview generator 218, a UI element animator 220, a metadata label presenter 224, and a content store 204, in one embodiment. The content publishing system 150 may communicate data over one or more networks 210 with other elements of system 100, such as user devices 190, one or more content repositories 178, and one or more third party systems 208.

Metadata for the media content items 175, among other aspects, are stored in a metadata store 202 for retrieval and generation as labels overlaying content items 175 by a metadata label generator 216. As part of various content ingestion and/or curation processes, metadata may be collected for some or all of the content items 175 from various sources (e.g. from content providers and/or specialized metadata providers). Metadata may, for instance, be embedded within the content items 175, embedded within content feeds from which the content items 175 are obtained, or specified when the content items 175 are uploaded to the content distributor's system. Additional associated metadata for content items 175 may be generated or retrieved after receiving the content 175, whether to supplement or substitute existing metadata. Examples of such metadata may include, for instance, titles, actors, release years, genres, categories, tags, studios, directors, etc. Metadata for a content item 175 may be exposed as a metadata descriptor tag 112 (as illustrated in FIG. 1B) to assist a viewing user in selecting between multiple versions of content as presented in a user interface in the system 100. A metadata label generator 216 may generate the metadata descriptor tags 112, in an embodiment.

A user interface (UI) generator 214 generates a user interface to include alternate versions of content items 175 as alternative content 170. A user interface may include various user interface elements, such as dividers, buttons, and links to content items 175. The UI generator 214 uses the metadata label generator 216 to enable a content administrator user to discover relevant metadata descriptor tags that assist a viewing user in selecting between multiple versions of a content item 175. For example, metadata descriptor tags may include “SCARY,” “SUPER SCARY,” “PREMIUM,” and so on.

A content item selector 212 enables a viewing user of a user interface generated by the UI generator 214 to select between multiple versions of a content item 175. The content item selector 212 presents a mechanism by which the user may select between multiple versions of the content item. For example, a user may swipe, or perform a touch-screen interface gesture, left or right to select a version of the content item. As another example, a user may tap on the left or right side of the content item to select the associated version as represented in the content item. In a further example, a user may swipe through one or more versions in a left or right direction, and then may also tap the screen, or otherwise select the version being presented in the user interface. Other way of selecting may also be implemented by the content item selector 212, such as clicking on a particular icon, swiping vertically or in an upward or downward motion, using gyroscopic detectors of a user device to parse through multiple versions of content, such as waving a device in an upward or downward direction, using one or more pointing devices to assist in selection of a version, and so forth.

A content preview generator 218 generates a preview of content associated with each version of the content item within the user interface. For example, a preview thumbnail or screenshot of content may be presented in an animated fashion as a user interacts with the user interface, such as when swiping or moving a user interface element in an outward direction towards an edge of the content item. A content preview is presented by the content preview generator 218 within the user interface as the user dynamically interacts with the user interface, in one embodiment. In an embodiment, the content preview generator 218 uses a backend persona analysis engine or any personal preference intelligence that can be gathered for a particular user to determine a relative area of each thumbnail as shown in the user interface. For example, personal preference intelligence may be gathered from third-party social networking services to determine that a particular user has a higher affinity for super scary content. As a result, the personalization engine may determine that the personalized preference of “SCARY” vs. “SUPER SCARY” for that user is 20% vs. 80%. The content preview generator 218 may then use that information to initially present the thumbnail area for that user with 20% of the “SCARY” version versus 80% of the “SUPER SCARY” version of the content.

A UI element animator 220 animates a UI element within a user interface generated by the UI generator 214 to draw the attention of the viewing user. For example, the UI element may be a divider button that moves left and / or right across the user interface while also dynamically presenting the content preview associated with each version of the content item. As another example, the UI element may become animated in response to a user interaction with the user interface, such as scrolling up or down such that the viewing user may become aware that additional content is available for viewing.

A content presenter 222 presents content in a content publishing system 150 for consumption by a viewing user. Content 170 may be presented in various user interfaces and formats, such as a menu and selection format, a carousal format of content items, and/or a listing of content items by genre or other metadata. Alternative content 170 is presented by a content presenter 222 as any other type of content 170 is presented in the content publishing system 150, in an embodiment. The alternative content 170 is packaged to render preview content dynamically and includes a UI element that may be animated in some embodiment. Once a version of content is selected by a viewing user, the content presenter 222 presents the playable content within the user interface by retrieving the selected content item from a content store 204 and/or a content repository 178. A content store 204 persistently stores content item 175 that are distributed from content repositories 178. However, a content publishing system 150 may enable an alternative content 170 to link to content items 175 stored at content repositories, in one embodiment.

A metadata label presenter 224 presents metadata labels as overlays over an alternative content 170 presented in a content publishing system 150. Such metadata labels may include content descriptors such as “SCARY,” “SUPER SCARY,” “PREMIUM,” and so forth. Other content descriptors may include MPAA ratings, parental warnings, special features, director's cut, and the like. Metadata may be stored in a metadata store 202 or in a third-party system 208, such as content distributors.

Here, the metadata labels and other user interface elements enable alternative content items to be consumed by viewing users with greater ease and performance. The display and organization of the multiple versions of content greatly improves the performance of the system because less content items are generated. For example, if every episode of a 20-episode series of a television show hand multiple versions, across multiple seasons, system may be greatly improved and enhanced by enabling a single content item package to represent each episode. This content item package utilizes a placeholder to display the different versions of the same content. Additionally, client systems, such as mobile devices, are improved because of this technology due to the better display and organization of the multiple versions of the content.

Systems 100 and 150 illustrate only one of many possible arrangements of components configured to provide the functionality described herein. Other arrangements may include fewer, additional, or different components, and the division of work between the components may vary depending on the arrangement. For example, in some embodiments, elements may be omitted, along with any other components relied upon exclusively by the omitted component(s). Although certain numbers of elements are depicted in FIG. 1 and FIG. 2, it will be apparent that system 100 may be utilized to publish any number of content items 175 to any number of clients 190, using any number of alternative content items 170 to generate any number of packages 185, and that any number of such packages 185 may be published on any number of sites 180 having any number of subsites 182.

### 3.0. Functional Overview

In an embodiment, among other aspects, publication of content items from, potentially, multiple providers and sources, to multiple sites and audiences is greatly simplified using centralized content curation and programming techniques, such as described herein.

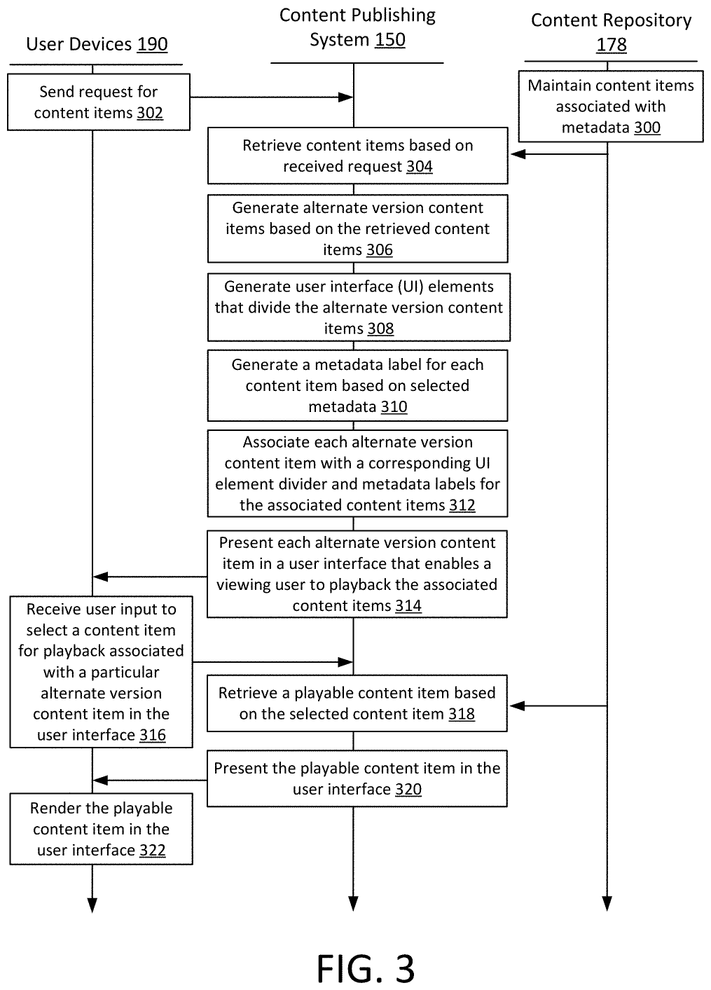

FIG. 3 illustrates an example interaction diagram for presenting alternate versions of content items, according to an embodiment. The various elements of the interaction diagram illustrated in FIG. 3 may be performed in a variety of systems, including systems such as systems 100 and 150, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

A content repository 178 maintains 300 content items associated with metadata. User devices 190 send 302 a request for content items to a content publishing system 150. Content items are retrieved 304 from the content repository 178 based on the received request. For example, a user device 190 may send a request for Bollywood television show episodes. There may be multiple versions of a single episode that may have different endings, different plots, different content, and/or additional content that may make the episode scarier, funnier, more exciting, and/or so forth.

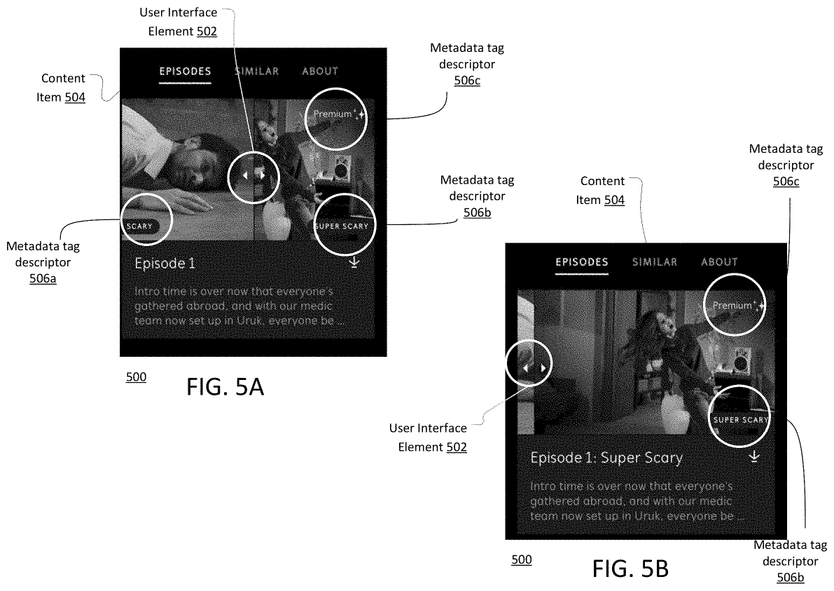

Alternate version content items are generated 306 based on the retrieved content items. Alternate version content items are packaged as a single content item for presentation to a user at a user device 190. Here, the packaging involves identifying the alternate versions of the content item based on metadata. UI elements that divide the alternate version content items are generated 308. This may be a vertical divider that creates a left and right side of a content item presented to a user device 190. A metadata label is generated 310 for each content item based on selected metadata. As shown in FIGS. 5A and 5B, for example, metadata descriptor tags that convey content descriptions, such as “SCARY” and “SUPER SCARY” may be generated 310. Other metadata descriptor tags may be generated 310, such as “PREMIUM,” “DIRECTOR'S CUT,” “Alternate Ending,” etc. An example data structure layout would include a database entry in which a content item is associated with a unique identifier, while alternate versions of the content item are each flagged with a content flag that indicates a relationship to the content item and a corresponding identifier that indicates the uniqueness of the alternative content. The database may be a relational database, in one embodiment, or may be a correlation file in other embodiments. The data structure may be unstructured in various embodiments.

Each alternate version content item is associated 312 with data representing corresponding UI elements, such as a divider and metadata labels, for the content items. This creates a single content item package that is then presented 314 in a user interface that enables a viewing user to playback the associated content items. The package is presented 314 to user devices 190, such as a mobile device, an Internet-enabled television, a set-top device, other computing devices and the like.

User input to select a content for playback is received 316 at user device 190 where the user input is associated with a particular alternate version content item in the user interface. As described above, a user input may include a touchscreen user interface gesture, such as a swipe motion, a tap gesture, a flick motion, and the like. A user input may also include a pointing motion, a pointing device selection, a click, a movement gesture captured by a motion sensor, and the like.

The selection as received by the user input is communicated to the content publishing system 150. A playable content item is then retrieved 318 from a content repository 178 based on the selected content item. The playable content item is presented 320 in the user interface. This is caused by the content publishing system 150 to be presented 320 on user devices 190. The presentation of the content item may be performed on a single user device 190 or on multiple devices 190, in various embodiments. The playable content item is then rendered 322 in the user interface on the user devices 190.

Content may be rendered 322 as a content package. For example, once content packages have been specified, and the relevant information describing those content packages (e.g., assignment data, placeholders, etc.) has been stored, the content items within those content packages are ready to be published. Generally, the publishing of the content item involves various steps, including sending a “link” to the content item to one or more clients. A link may, for example, take such forms as a uniform resource locator (“URL”), uniform resource identifier (“URI”), or other address or identifying information that references a location from which the content item may be requested, such as from a content distributor server or a third-party server. The link may be published by embedding the link within a web page, such as in the source of a hyperlink element on which a user may click to request the content item, or the source of a video element that is automatically played when the web page is loaded. The link may alternatively be published by including the link in information returned to various client applications that interface with the content publishing system, such as in a JSON stream returned by the server in response to an API call from the client to fetch a list of available content items.

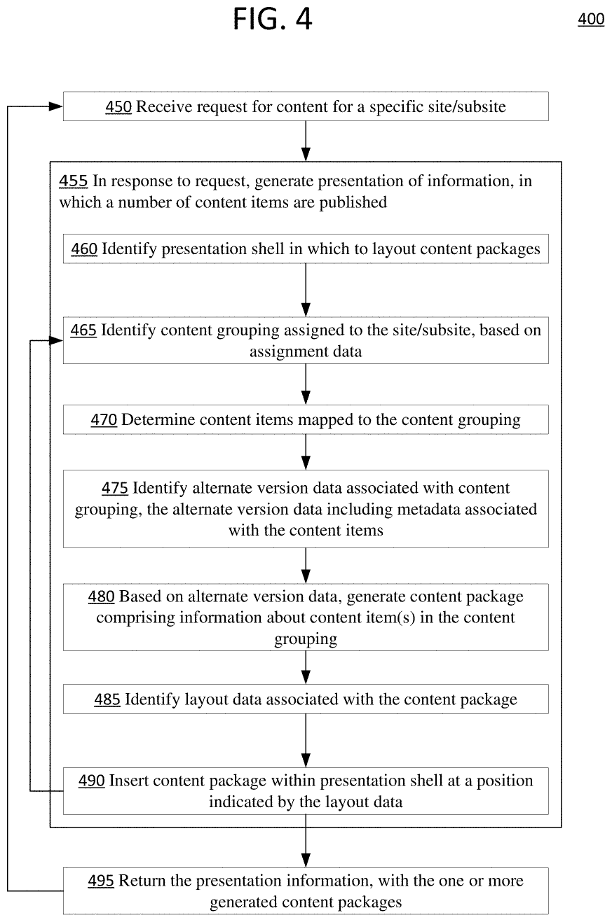

FIG. 4 illustrates an example flow 400 for publishing content packages to a dynamically-generated site or subsite, according to an embodiment. As with flow 300, the various elements of flow 400 may be performed in a variety of systems, including systems such as systems 100 and 150, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

Block 450 comprises receiving a request for content for a specific site or subsite. For instance, a client such as a client 190 may send an HTTP request over a network for a web page from a subsite 182 hosted by a web application server. Or, a client application may send an API request for content packages to show within certain areas of an application interface.

Block 455 comprises, in response to the request, generating a presentation of information, such as a web page or application screen, in which a number of content items are published. Block 455 is subdivided into blocks 460-490.

Block 460 comprises identifying the presentation shell or template in which to layout content packages. For instance, if the presentation will take the form of a web page, block 460 may comprise generating the containing web page structure, with designated sections into which content packages may be placed. More generally, block 460 comprises generating some containing presentation structure into which content packages may be inserted.

Block 465 comprises identifying a content grouping assigned to the site or subsite, based on assignment data, including the assignment data stored in block 325. For instance, an assignment subsystem, such as assignment subsystem 215, may query a database of assignment data to locate the identifier of each content grouping assigned to the site or subsite requested in block 450. Each identified content grouping may be processed, in turn. In an embodiment, block 465 may comprise identifying placeholders that are active for or otherwise associated with the site, and then determining, for each placeholder, what content grouping is identified.

Block 470 comprises determining one or more content items that are mapped to the content grouping. These content items may have originally been indicated in performance of step such as described in block 310. In some embodiments, the determining may simply involve looking up all content items mapped to the content grouping in a data repository, such as one or more context repositories 180. In other embodiments, the determining may further involve accessing content feeds and/or other listings that have been mapped to the content grouping to identify content items that are currently in the listings. Note that the one or more content items mapped to the content grouping may have changed since the content grouping was initially specified, as a result of intermediate edits to the content grouping or to an underlying feed or content listing referenced by the content grouping.

In an embodiment, the identified one or more content items need not necessarily include all content items that are mapped to the content grouping. For example, on account of space limitations, only a certain number of content items may be published in the content package for the content grouping. Block 470 may thus involve sorting the content items by some ranking mechanism (e.g. popularity, recently accessed, etc.) and selecting only a top certain number of content items in said sorting.

Block 475 comprises identifying alternate version data associated with the content grouping, the alternate version data including metadata associated with the content items. For example, block 475 may comprise identifying a particular parameter associated with the alternate version data indicating the content item has multiple versions. The alternate version data may be found in, or otherwise associated with, the metadata associated with content items.

Block 480 comprises, based on the alternate version data, generating a content package comprising information about some or all of the one or more content items in the content grouping. The content package may be generated as described in other sections herein (e.g. by an alternate content item generator 206).

Block 485 comprises identifying layout data associated with the content package, such as layout data stored in block 345. The layout data may be found in, or otherwise associated with, the metadata.

Block 490 comprises inserting the content package within the presentation shell identified in block 460, at a position indicated by the layout data. For instance, the layout data may indicate to place the content package in a banner section, sidebar section, category section, or other specified location. If another content package has already been inserted in the specified section, the new content package may be placed above, below, or beside the other content package, depending on the embodiment and/or the layout data.

Blocks 465-490 are then repeated for each content grouping identified within the assignment data as being associated with the site or subsite.

Block 495 comprises returning the presentation information, with the one or more content packages generated via blocks 465-490, to the client, which is configured to display a presentation to a user based on the returned information. For instance, if the presentation is a web page, block 495 may comprise returning HTML and/or JavaScript instructions to the client's browser, which, when interpreted, are rendered as a web page to display at the client. In returning the presentation information, information about the content items identified in block 470 is published to the client. The client may then access (e.g., request) the content items based on the published information.

Flow 400 is but one example of a method by which content items within a content package may be published. Others methods may include fewer or additional steps in varying orders. For example, in an embodiment, flow 400 may further involve a step of filtering the content items and/or the identified contexts based on rights data, such as described with respect to rights manager 215. As another example, flow 400 may involve a step of applying a site-level customization to a content package. Note that blocks 450-495 may be performed any number of times, for any number of clients and any number of sites or subsites.

While flow 400 deals with dynamically generated presentations, such as dynamically generate web pages, variations upon flow 400 may be utilized to generate static presentations. For instance, instead of block 450 being a request for content from a site, block 450 may be a determination that it is time to generate or update a static presentation, such as a static web page, either because some periodic interval has lapsed, or because some other triggering condition has been met. Block 495 then comprises storing the generated or updated static presentation.

According to some embodiments, variations upon flow 400 may further subdivide performance of the described steps amongst two or more entities. For example, a third-party server system or client may perform steps 460 and 490, but request that the content distributor's server system perform some are all of steps 465-485, and return the relevant output.

### 4.0. Example Interfaces

FIGS. 5A-B illustrate an example user interface for selecting between alternate versions of content within a package, according to an embodiment. The example interfaces may be generated by, for example, a web server or application server in communication with a client browser or application over a network. The interfaces provide various interface controls, referred to as fields, through which users submit input that specifies various attributes to the content publishing system. In an embodiment, some or all of interfaces may be provided by a content programming subsystem, such as content presenter 222. Of course, in other embodiments there are a wide variety of other interfaces that may be utilized for editing the same data structures, and it will further be recognized that the various data attributes collected by the example interfaces are but examples of attributes that may be utilized in practicing the described techniques. In other embodiments, many of the attributes may be optional, eliminated, and/or replaced by different attributes.

FIG. 5A illustrates an example user interface 500 selecting between alternate versions of content within a package, according to an embodiment. Interface 500 comprises elements 502-506.

User interface element 502 comprises a divider that assists the viewing user in selecting between two versions of the content item 504. A metadata tag descriptor 506a “SCARY” indicates that the left-hand side of the content item 504 is “SCARY” while a metadata tag descriptor 506b “SUPER SCARY” indicates that the right-hand side of the content item 504 is “SUPER SCARY.” Additionally, a metadata tag descriptor 506c “Premium” is an image overlay over the right-hand side of the content item 504, indicating that the user may need premium access rights to view the content on the right-hand side of the content item 504.

FIG. 5B further illustrates the example user interface 500 after a viewing user has interacted with the interface 500. For example, the divider user interface element 502 has moved from the center of the content item 504 to a left side of the content item 504. Additionally, a larger content preview is presented that represents the “SUPER SCARY” alternate version of the content item 504.

In another embodiment, the divider user interface element 502 may be animated to move left or right as a user scrolls through a listing of the content items presented in the interface 500. In a further embodiment, once a user swipes left or selects the right-hand side content item, the playable content item associated with the “SUPER SCARY” content item may be retrieved and rendered within the interface 500. In this embodiment, the swipe left or viewing user selection of the right-hand side of the content item is a user interface element selection (e.g., a gesture command or a tap on a touchscreen, a sliding motion or a click using a pointing device, etc.) that indicates the viewing user's intention to initiate playback of the desired content presented in the interface 500. The interface 500 may then begin playback of the alternative content 170 associated with the content item 504. In this way, the selection mechanism of the alternative content item is improved, thereby increasing system performance and the viewing user experience.

### 5.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

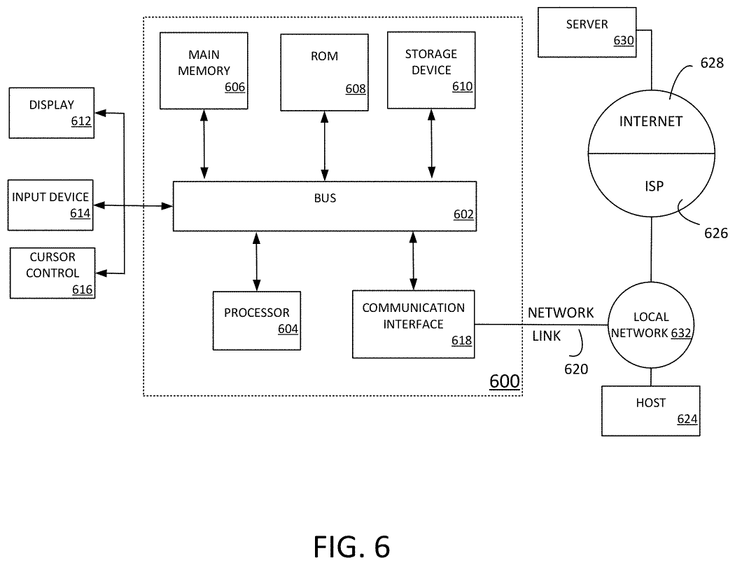

FIG. 6 is a block diagram that illustrates a computer system 600 utilized in implementing the above-described techniques, according to an embodiment. Computer system 600 may be, for example, a desktop computing device, laptop computing device, tablet, smartphone, server appliance, computing mainframe, multimedia device, handheld device, networking apparatus, or any other suitable device.

Computer system 600 includes one or more busses 602 or other communication mechanism for communicating information, and one or more hardware processors 604 coupled with busses 602 for processing information. Hardware processors 604 may be, for example, a general purpose microprocessor. Busses 602 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 600 also includes a main memory 606, such as a random access memory (RAM) or other dynamic or volatile storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes one or more read only memories (ROM) 608 or other static storage devices coupled to bus 602 for storing static information and instructions for processor 604. One or more storage devices 610, such as a solid-state drive (SSD), magnetic disk, optical disk, or other suitable non-volatile storage device, is provided and coupled to bus 602 for storing information and instructions.

Computer system 600 may be coupled via bus 602 to one or more displays 612 for presenting information to a computer user. For instance, computer system 600 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 612 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 612.

In an embodiment, output to display 612 may be accelerated by one or more graphics processing unit (GPUs) in computer system 600. A GPU may be, for example, a highly parallelized, multi-core floating point processing unit highly optimized to perform computing operations related to the display of graphics data, 3D data, and/or multimedia. In addition to computing image and/or video data directly for output to display 612, a GPU may also be used to render imagery or other video data off-screen, and read that data back into a program for off-screen image processing with very high performance. Various other computing tasks may be off-loaded from the processor 604 to the GPU.

One or more input devices 614 are coupled to bus 602 for communicating information and command selections to processor 604. One example of an input device 614 is a keyboard, including alphanumeric and other keys. Another type of user input device 614 is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Yet other examples of suitable input devices 614 include a touch-screen panel affixed to a display 612, cameras, microphones, accelerometers, motion detectors, and/or other sensors. In an embodiment, a network-based input device 614 may be utilized. In such an embodiment, user input and/or other information or commands may be relayed via routers and/or switches on a Local Area Network (LAN) or other suitable shared network, or via a peer-to-peer network, from the input device 614 to a network link 620 on the computer system 600.

A computer system 600 may implement techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 600 can receive the data on the network and demodulate the signal to decode the transmitted instructions. Appropriate circuitry can then place the data on bus 602. Bus 602 carries the data to main memory 606, from which processor 604 retrieves and executes the instructions. The instructions received by main memory 606 may optionally be stored on storage device 610 either before or after execution by processor 604.

A computer system 600 may also include, in an embodiment, one or more communication interfaces 618 coupled to bus 602. A communication interface 618 provides a data communication coupling, typically two-way, to a network link 620 that is connected to a local network 622. For example, a communication interface 618 may be an integrated services digital network (ISDN) card, cable modem, satellite modem, or a modem to provide a data communication connection to a corresponding type of telephone line. As another example, the one or more communication interfaces 618 may include a local area network (LAN) card to provide a data communication connection to a compatible LAN. As yet another example, the one or more communication interfaces 618 may include a wireless network interface controller, such as a 802.11-based controller, Bluetooth controller, Long Term Evolution (LTE) modem, and/or other types of wireless interfaces. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by a Service Provider 626. Service Provider 626, which may for example be an Internet Service Provider (ISP), in turn provides data communication services through a wide area network, such as the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

In an embodiment, computer system 600 can send messages and receive data, including program code and/or other types of instructions, through the network(s), network link 620, and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution. As another example, information received via a network link 620 may be interpreted and/or processed by a software component of the computer system 600, such as a web browser, application, or server, which in turn issues instructions based thereon to a processor 604, possibly via an operating system and/or other intermediate layers of software components.

In an embodiment, some or all of the systems described herein may be or comprise server computer systems, including one or more computer systems 600 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
retrieving multiple identifiers of multiple alternative versions of a specific content title;
generating a user interface comprising, for each alternative version of the specific content title, a content preview associated with the alternative version and at least one metadata descriptor tag associated with the alternative version, the user interface further comprising a user interface element dividing the content previews of the multiple alternative versions of the specific content title within the user interface;
presenting the user interface to the user device, the presenting causing rendering of the user interface at a user device;
receiving user input from the user device, the user input indicating a selected alternative version of the specific content title;
retrieving, from a content repository, the selected alternative version of the specific content title based on the identifier associated with the selected alternative version of the specific content title; and
presenting a playable content item associated with the selected alternative version of the specific content title to the user device.

2. The method of claim 1, wherein the user interface element is animated based on receiving a user input from the user device.

3. The method of claim 1, wherein the user input comprises a swipe motion that selects an alternative version of the specific content title based on a directionality of the swipe motion.

4. The method of claim 1, further comprising dynamically causing rendering of the content preview for an alternative version at the user device based on the user input.

5. The method of claim 1, further comprising causing playback of the playable content item at the user device based on the user input.

6. The method of claim 1, further comprising selecting, for each alternative version, the at least one metadata descriptor tag based on a description of the specific content title.

7. The method of claim 1, further comprising selecting a premium metadata descriptor tag as one of the at least one metadata descriptor tag.

8. A non-transitory computer readable medium storing a program of instructions that is executable by a device to perform a method, the method comprising:
retrieving multiple identifiers of multiple alternative versions of a specific content title;
generating a user interface comprising, for each alternative version of the specific content title, a content preview associated with the alternative version and at least one metadata descriptor tag associated with the alternative version, the user interface further comprising a user interface element dividing the content previews of the multiple alternative versions of the specific content title within the user interface;
presenting the user interface to the user device, the presenting causing rendering of the user interface at a user device;
receiving user input from the user device, the user input indicating a selected alternative version of the specific content title;
retrieving, from a content repository, the selected alternative version of the specific content title based on the identifier associated with the selected alternative version of the specific content title; and
presenting a playable content item associated with the selected alternative version of the specific content title to the user device.

9. The non-transitory computer readable medium of claim 8, wherein the user interface element is animated based on receiving a user input from the user device.

10. The non-transitory computer readable medium of claim 8, wherein the user input comprises a swipe motion that selects an alternative version of the specific content title based on a directionality of the swipe motion.

11. The non-transitory computer readable medium of claim 8, the method further comprising dynamically causing rendering of the content preview for an alternative version at the user device based on the user input.

12. The non-transitory computer readable medium of claim 8, the method further comprising causing playback of the playable content item at the user device based on the user input.

13. The non-transitory computer readable medium of claim 8, the method further comprising selecting, for each alternative version, the at least one metadata descriptor tag based on a description of the specific content title.

14. The non-transitory computer readable medium of claim 8, the method further comprising selecting a premium metadata descriptor tag as one of the at least one metadata descriptor tag.

15. An apparatus, comprising:
an alternative version retrieval device, implemented at least partially in hardware, configured to retrieve multiple identifiers of multiple alternative versions of a specific content title;
a user interface generator, implemented at least partially in hardware, configured to generate a user interface comprising, for each alternative version of the specific content title, a content preview associated with the alternative version and at least one metadata descriptor tag associated with the alternative version, the user interface further comprising a user interface element dividing the content previews of the multiple alternative versions of the specific content title within the user interface;
a user interface presentation device, implemented at least partially in hardware, configured to present the user interface to the user device, the presenting causing rendering of the user interface at a user device;
a user input receiver, implemented at least partially in hardware, configured to receive user input from the user device, the user input indicating a selected alternative version of the specific content title;
wherein the alternative version retrieval device retrieve, from a content repository, the selected alternative version of the specific content title based on the identifier associated with the selected alternative version of the specific content title;
wherein the user interface presentation device present a playable content item associated with the selected alternative version of the specific content title to the user device.

16. The apparatus as recited in claim 15, wherein the user interface element is animated based on receiving a user input from the user device.

17. The apparatus as recited in claim 15, wherein the user input comprises a swipe motion that selects an alternative version of the specific content title based on a directionality of the swipe motion.

18. The apparatus as recited in claim 15, further comprising a subsystem, implemented at least partially in hardware, configured to dynamically cause rendering of the content preview for an alternative version at the user device based on the user input.

19. The apparatus as recited in claim 15, further comprising a subsystem, implemented at least partially in hardware, configured to cause playback of the playable content item at the user device based on the user input.

20. The apparatus as recited in claim 15, further comprising a subsystem, implemented at least partially in hardware, configured to select, for each alternative version, the at least one metadata descriptor tag based on a description of the specific content title.
